(19) United States
(12) Patent Application Publication
(10) Pub. No.: US 2026/0208558 A1
(43) Pub. Date: Jul. 23, 2026

(54) VEHICLE AIR-CONDITIONING CONTROL SYSTEM

(71) Applicant: TOYOTA JIDOSHA KABUSHIKI KAISHA, Toyota-shi (JP)

(72) Inventors: Keigo YOSHIDA, Nisshin-shi (JP); Yoshinori Okuno, Okazaki-shi (JP); Masashi Kamiya, Okazaki-shi (JP); Daisuke Sakamoto, Miyoshi-shi (JP); Junichi Yoshimatsu, Nagoya-shi (JP)

(73) Assignee: TOYOTA JIDOSHA KABUSHIKI KAISHA, Toyota-shi (JP)

(21) Appl. No.: 19/310,255

(22) Filed: Aug. 26, 2025

(30) Foreign Application Priority Data
Jan. 17, 2025 (JP) 2025-007128

(51) Int. Cl. B60H 1/00

(52) U.S. Cl. CPC B60H 1/00735; B60H 1/00828; B60H 2001/00949

(57) ABSTRACT

A vehicle air-conditioning control system comprising: a control unit that changes a correction amount of a predetermined target index relating to a temperature setting of an air conditioning unit in a vehicle cabin based on an operation status of a plurality of radiant heaters installed in the vicinity of a seat in the vehicle cabin and a thermal device other than the radiant heaters.

### CROSS-REFERENCE TO RELATED APPLICATION

This application claims priority to Japanese Patent Application No. 2025-007128 filed on Jan. 17, 2025. The disclosure of the above-identified application, including the specification, drawings, and claims, is incorporated by reference herein in its entirety.

### BACKGROUND

### 1. Technical Field

The present disclosure relates to a vehicle air-conditioning control system.

### 2. Description of Related Art

Japanese Unexamined Patent Application Publication No. 2019-116242 (JP 2019-116242 A) describes a vehicle heating device capable of enhancing the thermal sensation of an occupant.

### SUMMARY

When radiant heaters installed near a seat of a vehicle or other thermal devices are operated, a situation may occur in which the vehicle cabin is warmed earlier than the set temperature of the air conditioning. This may result in a deviation from the temperature environment assumed by a user, temporarily impairing comfort.

An object of the present disclosure is to provide a vehicle air-conditioning control system that enhances comfort by suppressing the deviation between the cabin temperature and the sensible temperature of the user.

An aspect of the present disclosure provides a vehicle air-conditioning control system including
a control unit configured to change a correction amount for a predetermined target index related to temperature setting of an air conditioning unit in a vehicle cabin based on an operation status of a plurality of radiant heaters installed near a seat in the vehicle cabin and a thermal device other than the radiant heaters.

In the vehicle air-conditioning control system according to this aspect, the deviation between the cabin temperature and the sensible temperature of the user is suppressed during the operation of the air-conditioning, the radiant heaters, and the thermal device, thereby enhancing comfort.

In the vehicle air-conditioning control system according to the above aspect,
the control unit may be configured to change the correction amount using at least one of a required blowout temperature, a target heater water temperature, and blower delayed operation for the air conditioning unit as the target index.

In the vehicle air-conditioning control system according to this aspect, the correction amount for any target index of the air conditioning unit can be changed, thereby enhancing comfort flexibly according to the index.

In the vehicle air-conditioning control system according to the above aspect,
the control unit may be configured to change the correction amount, based on a number of the radiant heaters operating and presence or absence of the thermal device operating in the operation status, so as to reduce the target index as a number of operating devices is larger.

In the vehicle air-conditioning control system according to this aspect, the correction amount can be set according to the number of devices operating other than the air-conditioning so as to suppress a deviation from the sensible temperature of the user.

In the vehicle air-conditioning control system according to the above aspect,
the control unit may be configured to set operation and stop of each of the radiant heaters.

In the vehicle air-conditioning control system according to this aspect, it is possible to adjust the temperature according to the needs of the user by individually setting operation and stop of the radiant heaters.

As described above, according to the present disclosure, it is possible to enhance comfort by suppressing the deviation between the cabin temperature and the sensible temperature of the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a vehicle air-conditioning control system provided in a vehicle according to an embodiment;

FIG. 2 is a schematic diagram illustrating an example of a configuration of an air conditioning unit according to the embodiment;

FIG. 3 is a block diagram illustrating an example of an electrical configuration of a control unit according to the embodiment;

FIG. 4 is a graph illustrating an exemplary correspondence between a required blowout temperature and an outside air temperature according to the embodiment; and

FIG. 5 is a flowchart illustrating an example of a flow of processing performed by the control program according to the embodiment.

### DETAILED DESCRIPTION OF EMBODIMENTS

Exemplary embodiments of the present disclosure will be described in detail below with reference to the drawings.

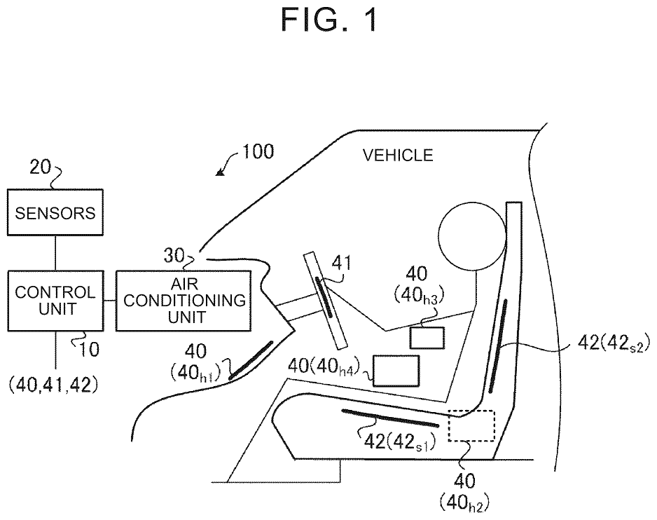

FIG. 1 is a diagram illustrating an example of a configuration of a vehicle air-conditioning control system 100 provided in a vehicle according to the present embodiment. As illustrated in FIG. 1, a vehicle air-conditioning control system 100 according to the present embodiment includes a control unit 10, sensors 20, an air conditioning unit 30, a radiant heater 40, a steering heater 41, and a seat heater 42. The vehicle air-conditioning control system 100 according to the present embodiment includes a plurality of radiant heaters 40, a steering heater 41, and a seat heater 42, but the steering heater 41 and the seat heater 42 need only include at least one. The steering heater 41 and the seat heater 42 are examples of the thermal device of the present disclosure.

The control unit 10 is configured as, for example, an ECU (Electronic Control Unit). The sensors 20 include, for example, a room temperature sensor, an outside air temperature sensor, and a solar radiation sensor, and detect temperature information inside and outside the vehicle cabin. The room temperature sensor detects a room temperature which is an air temperature in the vehicle cabin, the outside air temperature sensor detects an outside air temperature which is an air temperature outside the vehicle, and the solar radiation sensor detects an amount of solar radiation entering the vehicle cabin. The air conditioning unit 30 adjusts the temperature of the introduced air and supplies the air to the vehicle cabin.

The radiant heater 40, the steering heater 41, and the seat heater 42 are examples of heaters, and are provided at predetermined locations in the vehicle cabin. The radiant heater 40 is a radiant heater, and the steering heater 41 and the seat heater 42 are heat transfer heaters. In FIG. 1, the radiant heater 40 is configured as a plurality of radiant heaters 40, which are provided in the steering column lower side (40ₕ₁), the console lateral side (40ₕ₂), the door trim upper side (40ₕ₃), and the door trim lower side (40ₕ₄). The steering heater 41 is provided in the steering, and the seat heater 42 is provided in the seat. The seat heaters 42 are provided on the seat portion (42ₛ₁) and the back rest (42ₛ₂), respectively.

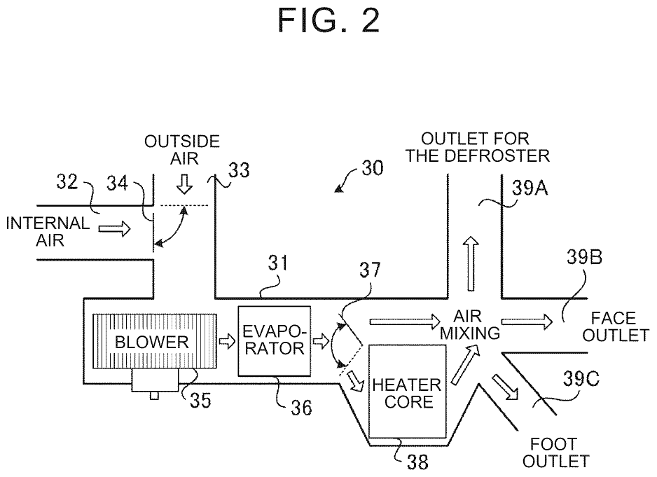

FIG. 2 is a schematic diagram illustrating an example of a configuration of the air conditioning unit 30 according to the present embodiment. The open arrows in FIG. 2 indicate the flow of air. The air conditioning unit 30 according to the present embodiment includes a housing 31. An inside air intake port 32 and an outside air intake port 33 are provided at an upstream end of the housing 31. The inside air intake port 32 is an air inlet for taking in the air in the vehicle cabin into the housing 31. The outside air intake port 33 is an air inlet for taking in air outside the vehicle into the housing 31. An inside/outside air switching door 34 is provided adjacent to the inside air intake port 32 and the outside air intake port 33. The inside/outside air switching door 34 is driven by an actuator (not shown) to change the degree of opening between the inside air intake port 32 and the outside air intake port 33. A blower 35 as a blower is provided downstream of the inside/outside air switching door 34. The blower 35 takes in air from the inside air intake port 32 or the outside air intake port 33 and feeds it to the downstream side of the housing 31. An evaporator 36, an air mixing door 37, and a heater core 38 are disposed downstream of the blower 35. During the cooling operation, the evaporator 36 cools the air sent from the blower 35 by the latent heat when the air-conditioning refrigerant is vaporized. The cooled air-conditioned air is output to the interior of the vehicle, thereby cooling the interior of the vehicle. The air mixing door 37 is disposed upstream of the heater core 38, and adjusts the amount of air passing through the heater core 38. During the heating operation, the air mixing door 37 moves to a position where the heater core 38 is not blocked. As a result, the air sent from the blower 35 passes through the heater core 38 and is heated. The heated air-conditioned air is output to the inside of the vehicle, thereby heating the inside of the vehicle. The downstream end of the housing 31 is divided into a plurality of (in the illustrated example, three) passages, each of which is connected to a specific air outlet. In the present embodiment, as the air outlet, there are a defroster air outlet 39A facing the windshield, a face air outlet 39B facing the face of the occupant, and a foot air outlet 39C facing the foot of the occupant.

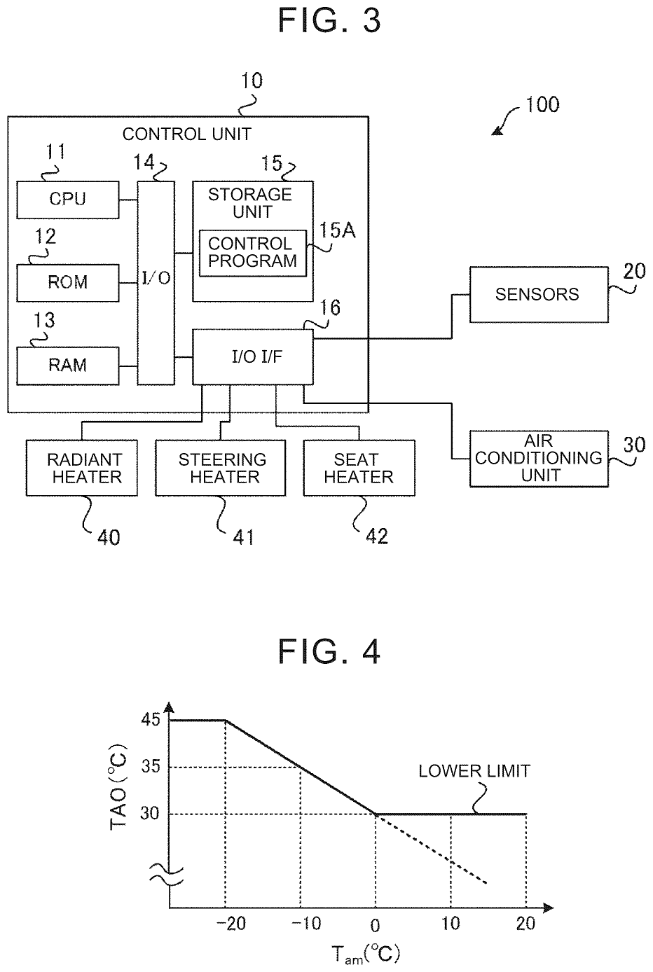

FIG. 3 is a block diagram illustrating an example of an electrical configuration of the control unit 10 according to the present embodiment. The control unit 10 according to the present embodiment includes a CPU (Central Processing Unit) 11, a ROM (Read Only Memory) 12, a RAM (Random Access Memory) 13, an input/output unit (I/O) 14, a storage unit 15, and an input/output interface (input/output I/F) 16. CPU 11, ROM 12, RAM 13 and I/O 14 are connected to each other via busses. Functional units including a storage unit 15 and an input/output I/F 16 are connected to I/O 14. These functional units can communicate with CPU 11 via I/O 14.

As the storage unit 15, for example, HDD (Hard Disk Drive), SSD (Solid State Drive), flash memory, or the like is used. The storage unit 15 stores control program 15A. The control program 15A may be stored in ROM 12. The control program 15A may be installed in the control unit 10 in advance, for example. The control program 15A may be implemented by being stored in a non-volatile storage medium or distributed over a network and appropriately installed in the control unit 10. The nonvolatile storage medium may be a CD-ROM (Compact Disc Read Only Memory), a magneto-optical disk, a HDD, DVD-ROM (Digital Versatile Disc Read Only Memory), a flash memory, a memory card, or the like.

The input/output I/F 16 are interfaces for connecting to the sensors 20, the air conditioning unit 30, the radiant heater 40, the steering heater 41, and the seat heater 42. The control unit 10 is a controller that controls operations of the sensors 20, the air conditioning unit 30, the radiant heater 40, the steering heater 41, and the seat heater 42.

CPU 11 of the control unit 10 according to the present embodiment executes the following control by writing the control program 15A stored in ROM 12 or the storage unit 15 to RAM 13 and executing it.

As an example, the control unit 10 controls the air conditioning unit 30 based on the required blowout temperature set as the target index. The required blowing temperature is set based on room temperature, outside air temperature, and solar radiation amount. The required blowout temperature is referred to as TAO (Temperature Air Output), and is a temperature obtained by calculating how many times the wind should be emitted from a preset set temperature, an outside air temperature, a room temperature, and a solar radiation amount. Specifically, for example, it is represented by the following formula (1). Here, Tₛₑₜ is the target setting temperature, Tᵣ is the room temperature, Tₐₘ is the outside air temperature, ST is the solar radiation amount, Kₛₑₜ, Kᵣ, Kₐₘ is the correction factor, and C is the constant.

$$TAO = {K}_{set} \times {T}_{set} - {K}_{r} \times {T}_{r} - {K}_{am} \times {T}_{am} - {K}_{s} \times ST + C \qquad ( 1 )$$

That is, the control unit 10, as represented by the above Expression (1), considering the temperature information of the target set temperature, room temperature, outside air temperature, and the solar radiation amount, the temperature in the vehicle cabin corresponding to the respective temperature information controls the required blowout temperature TAO so that the target set temperature.

FIG. 4 is a diagram illustrating an exemplary correspondence between the required blowout temperature TAO and the outside air temperature Tₐₘ according to the present embodiment. In the embodiment of FIG. 4, the relationship between the required blowout temperature TAO and the outside air temperature Tₐₘ is shown, but the relationship between the required blowout temperature TAO and the room temperature Tᵣ or the solar radiation ST may be shown. Here, the lower limit of the required blowout temperature TAO is set to, for example, 30° C. with respect to the outside air temperature Tₐₘ. The dotted line indicates the correspondence between the required blowout temperature TAO and the outside air temperature Tₐₘ when the lower limit value is not set. The lower limit of the required blow-off temperature TAO is determined based on, for example, the sensory evaluation. Specifically, as described above, the air conditioning unit 30 includes the heater core 38. The control unit 10 controls the temperature of the air that has passed through the heater core 38 to be equal to or higher than the lower limit of the required blowout temperature TAO.

In the present embodiment, the control unit 10 changes the correction quantity of the required blowout temperature TAO, which is the target index, based on the operating conditions of the radiant heaters 40 and the thermal devices. For example, the air conditioning unit 30 is controlled by changing the correction amount from the start of the operation of the air conditioning unit 30, the radiant heater 40, and the thermal device until a predetermined time (a setting of about several minutes) has elapsed.

For example, the correction amount is assumed to be α1. The control unit 10 calculates the required blowout temperature TAO_{α}after correction as in the following Expression (2) reflecting the correction quantity α1 in the required blowout temperature TAO which is a target index.

$${TAO}_{α} = TAO - α1 \qquad ( 2 )$$

In this way, corrections are made so that a value lower than the calculation of the required blowout temperature TAO described above is set. The control unit 10 operates the air conditioning unit 30 based on the corrected required blowout temperature TAO_{α}.

Correction amount α1, for example, based on the number of radiant heaters 40 in operation and the operation of the thermal device, the more the number is operating, to change the correction amount α1 so as to lower the target index. That is, the correction amount α1 may be set to be larger as the number of operations is larger. Further, as the target index, the required blowout temperature TAO has been described as an example. However, the present disclosure is not limited thereto, and the target heater water temperature (TWO: Temperature Water Output) and the control value of the blower slow movement may be targeted, and these correcting amounts may be changed. The target heater water temperature TWO is a target temperature of the water temperature of the heater core 38. The blower delay is an amount that delays the operation of the blower 35.

Further, for example, the correction quantity may be changed by changing the correction factor of Expression (1) as long as it is the required blowout temperature TAO. For example, the correction factor Kₛₑₜ for the target setpoint Tₛₑₜ is changed as a correction factor. Note that the correction coefficient Kᵣ for the room temperature Tᵣ, and the correction coefficient Kₐₘ for the outside air temperature Tₐₘ may be changed as the correction amount.

Further, the correction amount may be set according to a position where the radiant heater 40 or the thermal device is operating. For example, it has been obtained as an experimental result that the sensitivity of the site thermal sensation to the amount of heat input tends to increase in the order of the hip, back, upper arm, and thigh. Therefore, the magnitude of the correction amount α1 may be set in accordance with the arrangement of the radiant heater 40 and the thermal device being operated.

Arrangements close to the buttocks include, for example, a radiant heater 40 (40ₕ₂) on the side of the console) and a seat heater 42 (42ₛ₁). Therefore, when the radiant heater 40 (40ₕ₂) or the seat heater 42 (42ₛ₁) is operating, the correcting amount α1 is made larger than when the other radiant heaters 40 and the thermal devices are operating. On the other hand, the radiant heater 40 (40ₕ₁) below the steering column) and the steering heater 41 are not highly sensitive. Therefore, the correction amount α1 when the radiant heater 40 (40ₕ₁) or the steering heater 41 is operating is set to be smaller than the correction amount α1 when the other radiant heaters 40 and the thermal devices are operating.

In addition, the control unit 10 may be capable of setting the operation and the stop of each of the radiant heaters 40. It is assumed that the operation of each of the radiant heaters 40 is automatically set in accordance with a user's preference designation or a temperature difference. For example, the radiant heater 40 and the thermal device set by the user's preference are activated. This can meet the needs of the user, for example, that the radiant heater 40 (40ₕ₂) on the side of the console is unwilling to operate, but the radiant heater 40 (40ₕ₃) on the door trim is unwilling to operate. In addition, when the temperature difference is set, when the difference between the target set temperature Tₛₑₜ and the room temperature Tᵣ is small, only a part of the radiant heaters 40 and the thermal devices are set to operate, and the increase in the room temperature is adjusted so as to be gradual. When the difference between the target set temperature Tₛₑₜ and the room temperature Tᵣ is large, the radiant heater 40 and the thermal device are set to operate at a certain ratio or more. By controlling the operation of the radiant heater 40 and the thermal device in this way, it is possible to improve the comfort due to the room temperature change.

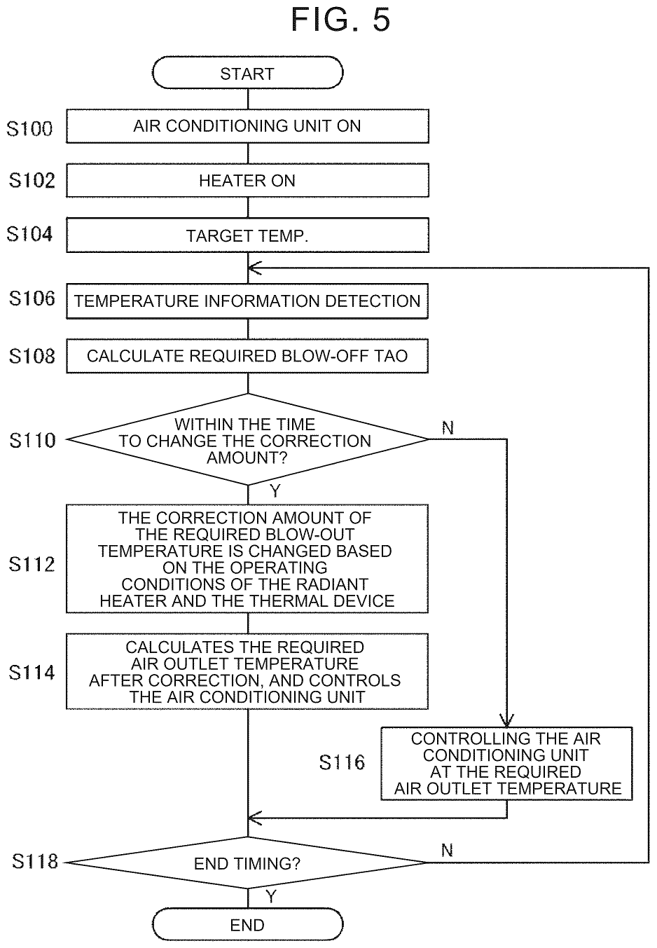

Next, the operation of the control unit 10 according to the present embodiment will be described with reference to FIG. 5. FIG. 5 is a flowchart illustrating an exemplary flow of a process performed by the control program 15A according to the present embodiment.

When the execution of the process by the control program 15A is instructed, CPU 11 of the control unit 10 is executed by writing the control program 15A stored in ROM 12 or the storage unit 15 to RAM 13.

In S100, CPU 11 turns on (operates) the air conditioning unit 30 in accordance with a user's manipulation.

In S102, CPU 11 turns on (operates) at least one of the radiant heater 40 and the thermal device (the steering heater 41 and the seat heater 42) according to a user's manipulation.

In S104, CPU 11 sets the target setpoint Tₛₑₜ in accordance with the user's manipulation.

In S106, CPU 11 detects room temperature Tᵣ, outside air temperature Tₐₘ, and solar radiation ST.

In S108, CPU 11 calculates the required blowout temperature TAO using Expression (1) described above.

In S110, CPU 11 determines whether or not the correction-amount change is to be performed. The time period during which the correction amount is changed is, for example, a certain time period such as a few minutes after the air conditioning unit 30 is turned on, a period until the operation of the radiant heater 40 and the thermal device is stopped, or a period until the room temperature Tᵣ reaches the target set temperature Tₛₑₜ. When it is determined that it is within the time, the process proceeds to S106, and when it is determined that it is not within the time, the process proceeds to S116.

In S112, CPU 11 changes the correcting quantity α1 of the required blowout temperature TAO of the air conditioning unit 30 in the vehicle cabin based on the operating conditions of the radiant heaters 40 and the thermal devices.

In S114, CPU 11 calculates the required blowout temperature TAO_{α}after the correction using the above-described Expression (2), and controls the air conditioning unit 30 according to the calculated required blowout temperature TAO_{α}.

In S116, CPU 11 controls the air conditioning unit 30 according to the calculated required blowout temperature TAO.

In S118, CPU 11 determines whether or not the operation of the air conditioning unit 30 is stopped (turned off), for example. When it is determined that the termination timing is not reached (negative determination), the process returns to S106 and the process is repeated. When it is determined that the end-timing has been reached (affirmative determination), the series of processes by the control program 15A is ended.

As described above, according to the present embodiment, the adjustment is performed by the correction amount of the target index so as to suppress the deviation between the temperature in the room and the sensible temperature of the user. Therefore, it is possible to improve the comfort during the operation of the air conditioning.

The technical scope of the present disclosure is not limited to the scope described in the above embodiments. Various modifications or improvements can be made to the above-described embodiments without departing from the gist, and the modifications or improvements are also included in the technical scope of the present disclosure.

What is claimed is:

1. A vehicle air-conditioning control system comprising a control unit configured to change a correction amount for a predetermined target index related to temperature setting of an air conditioning unit in a vehicle cabin based on an operation status of a plurality of radiant heaters installed near a seat in the vehicle cabin and a thermal device other than the radiant heaters.

2. The vehicle air-conditioning control system according to claim 1, wherein the control unit is configured to change the correction amount using at least one of a required blowout temperature, a target heater water temperature, and blower delayed operation for the air conditioning unit as the target index.

3. The vehicle air-conditioning control system according to claim 1, wherein the control unit is configured to change the correction amount, based on the number of the radiant heaters operating and presence or absence of the thermal device operating in the operation status, so as to reduce the target index as the number of operating devices is larger.

4. The vehicle air-conditioning control system according to claim 1, wherein the control unit is configured to set operation and stop of each of the radiant heaters.
